(19) United States
(12) Patent Application Publication
(10) Pub. No.: US 2008/0290606 A1
(43) Pub. Date: Nov. 27, 2008

(54) Mechanical Seal Assembly

(75) Inventor: Markus Schwerdtfeger, Mannheim (DE)

Correspondence Address: GUDRUN E. HUCKETT DRAUDT, SCHUBERTSTR. 15A, WUPPERTAL, 42289, DE

(73) Assignee: KACO GmbH & CO. KG, Heilbronn (DE)

(21) Appl. No.: 12/124,268

(22) Filed: May 21, 2008

(30) Foreign Application Priority Data
May 22, 2007 (DE) 10 2007 025 773.4

(51) Int. Cl. F16J 15/34

(52) U.S. Cl. 277/364

(57) ABSTRACT

A mechanical seal assembly has a housing fixedly secured on the shaft to be sealed. A slide ring is positive-lockingly connected to the housing. A counter ring interacts with the slide ring. The housing is frictionally connected to the shaft on a side of the slide ring facing away from the counter ring. A secondary seal is disposed in a cutout of the slide ring and secured by an axial securing element.

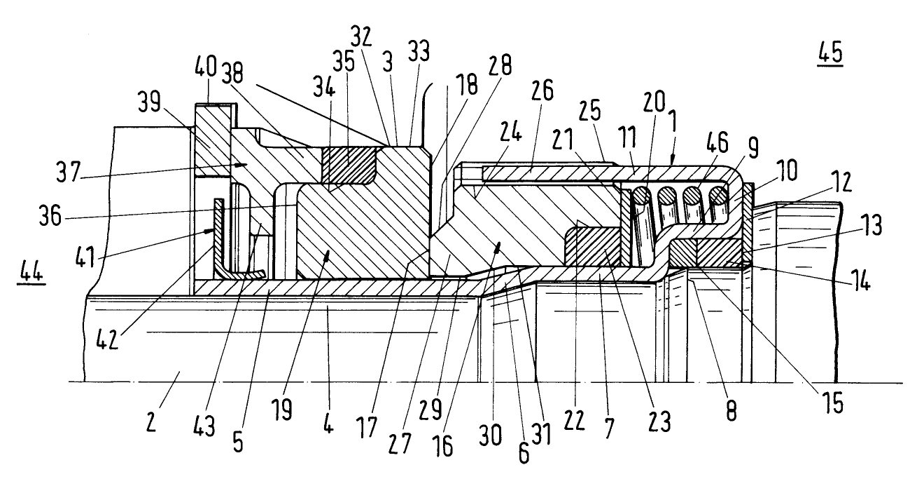

### BACKGROUND OF THE INVENTION

The invention relates to a mechanical seal assembly comprising a housing fixedly connected to a shaft to be sealed, a slide ring, and a counter ring interacting with the slide ring.

Mechanical seal assemblies are used, for example, in connection with water pumps or CO₂ compressors in automobiles. The installation of the different components of the mechanical seal assembly, particular of the slide ring and of the counter ring, is done in separate steps so that assembly of the mechanical seal assembly is complex and difficult.

### SUMMARY OF THE INVENTION

It is an object of the present invention to configure a mechanical seal assembly of the aforementioned kind in such a way that it can be installed easily.

In accordance with the present invention, this is achieved in that the slide ring is positive lockingly connected to the housing and the housing is frictionally connected to the shaft on a side of the slide ring facing away from the counter ring.

In the mechanical seal assembly according to the invention, the slide ring is connected by means of the secondary seal on the housing. The slide ring is positive lockingly connected to the housing as to rotate with the housing. The positive locking connection can be realized by means of tabs, notches, or similar means that engage matching cutouts or other matching means of the slide ring. The housing itself is frictionally connected to the shaft to be sealed. In this way, the torque is properly transmitted between the slide ring and the shaft. The hydraulic configuration of the mechanical seal assembly according to the present invention is determined in the area of the sealing element only by the easily realizable shaft fit at this location. In this connection, the housing is supported in the radial direction so that the hydraulic configuration of the mechanical seal assembly according to the invention cannot be affected negatively pressure-dependent deformation of the housing. Finally, the housing can be designed to be thin as a result of the configuration in accordance with the present invention. The mechanical seal assembly is particularly well suited for installation in compressors or for applications facing similar problems; in particular, it is suited for CO₂ compressors in automobiles.

### BRIEF DESCRIPTION OF THE DRAWING

The only FIGURE shows in axial section one half of a mechanical seal assembly according to the invention.

### DESCRIPTION OF THE PREFERRED EMBODIMENTS

The mechanical seal assembly according to the present invention is advantageously used for sealing a drive shaft of a CO₂ compressor in automobiles. The mechanical seal assembly has a housing 1 that is fixedly connected to a drive shaft 2. The housing 1 surrounds all other parts of the shaft seal assembly in a captive way. Accordingly, the mechanical seal assembly can be installed in one assembly step into the mounting space 3 from the drive side. The housing 1 has a cylindrical inner wall 4 which has a wall section 5 that passes by means of a conically widening intermediate wall section 6 into a second cylindrical wall section 7. The wall section 4 has a smaller inner and outer diameter in comparison to the wall section 7. The drive shaft 2 is provided with matching shaft sections on which the wall section 7 of the housing is fixedly secured.

The wall section 7 passes by means of a radially outwardly oriented flange 8 into a cylindrical part 9 that is coaxially positioned relative to the wall sections 5 to 7 and that is adjoined by a bottom 10 that is positioned at a right angle to the cylindrical part 9 and projects radially outwardly.

The bottom 10 of the housing 1 rests with interposition of an axial securing element in the form of an annular disk or washer 12 on a radial shoulder 13 of the drive shaft 2. Between the cylindrical part 9 and the drive shaft 2 there is a sealing ring 14 as a sealing element that ensures sealing between the housing 1 and the drive shaft 2. The sealing ring 14 is secured in its position by the washer 12 and the securing ring 15 that is seated on the drive shaft 2 and is supported on the radial flange 8 of the housing 1. The washer 12 ends radially in close proximity to the wall surface of the drive shaft 2.

Between the inner wall 4 and the outer wall 11 of the housing 1, a slide ring 16 is mounted and rests with its radial end face 17 seal-tightly against the radial end face 18 of the counter ring 19. The slide ring 16 rests with its end face that is remote from the counter ring 19 on a securing element in the form of a securing disk 20 that is fixedly secured on the wall section 7 for common rotation. The securing disk 20 is positioned in a radial plane and ends radially in close proximity to the outer wall 11. The securing disk 20 has a spacing from the flange 8 of the housing 1. The slide ring 16 is forced by spring 46 axially against the counter ring 19. The spring 46 (only schematically shown in the FIGURE) is preferably a coil pressure spring that is supported with one end on the bottom 10 and with the second end on the securing disk 20.

The slide ring 16 rests with radial end face 21 extending parallel to the end face 17 a really against the securing disk 20. The end face 21 is provided with a right angle cutout 22 into which the annular seal 23 is inserted that constitutes a secondary seal of the slide ring 16. The seal 23 is seated on the wall section 7 of the housing 1 and rests against the securing disk 20. The slide ring 16 is positive lockingly connected to the outer wall 11 of the housing 1. For this purpose, the slide ring 16 is provided at the outer wall surface 24 with outwardly projecting webs 25 that extend parallel to the axis of the assembly and are engaged by axially extending webs 26 provided on wall 11. In this way, the slide ring 16 is reliably entrained when the drive shaft 2 rotates.

The radial end face 17 resting against the counter ring 19 is provided on an axially projecting part 27 of the slide ring 16. The part 27 tapers continuously in the direction toward the end face 17. The projection 27 surrounds the wall section 5 of the housing 1 at a minimal radial spacing. The end face 17 is adjoined radially outwardly at an obtuse angle by the conical surface 28 and radially inwardly by the conical surface 29 of the slide ring 16. The conical surface 29 is coaxial to the wall section 5 and passes into a conical surface 30 and then into a cylindrical surface 31 where the cutout 22 opens. By means of the cylindrical surface 31 the slide ring 16 rests on the wall section 7 of the housing 1. In the area of the intermediate wall section 6 the slide ring 16 has a spacing from the housing 1.

The counter ring 19 has essentially a rectangular cross-section and is positioned with its radially outer cylindrical wall surface 32 on a wall 33 of the mounting space 3. In the wall surface 32 there is a circumferential recess 34 into which the sealing ring 35 is inserted. The sealing ring 35 rests seal-tightly against the wall 33 of the mounting space 3. The counter ring 19 surrounds at a minimal radial spacing the wall section 5 of the housing 1. The sealing ring 35 is axially secured in the recess 34 by an annular securing element 37. The securing element 37 surrounds the wall section 5 of the housing at a radial spacing and has an annular section 38 that projects into the recess 34 of the counter ring 19 and rests with its end face a really against the sealing ring 35. The radial thickness of the annular section 38 matches advantageously the radial thickness of the sealing ring 35.

The securing element 37, in turn, is axially secured in the mounting position by a securing element in the form of securing ring 39, preferably a Seeger ring. The securing ring 39 surrounds at a radial spacing the wall section 5 of the housing 1 and is inserted into an annular groove 40 in the wall 33 of the mounting space 3.

In order to prevent detachment of the securing element 37 when the mechanical seal assembly is not yet installed, the securing element 37 is provided with at least one closure element 41. In the illustrated embodiment, a ring that is L-shaped in cross-section is provided and secured on the wall section 5 of the housing 1 in a suitable way. It has a radial spacing from the securing ring 39 and from the securing element 37 so that when the drive shaft 2 rotates it will not contact any of these components. The radial leg 42 of the closure element 41 overlaps, when viewed in the axial direction of the mechanical seal assembly, a radial section 43 of the securing element 37 that ends at a spacing from the wall section 5 of the housing 1.

Instead of the circumferential closure element 41 it is also possible to provide on the wall section 5 individual closure elements that are distributed about the circumference and are secured on the wall section 5 in a suitable way. It is moreover possible to design the closure element 41 to be a unitary part of the wall section 5 in that the wall section 5 at the free end widens conically, for example. Also, it is possible to bend individual tongues out of the wall section 5.

In use of the mechanical seal assembly, the housing 1 rotates together with the drive shaft 2. By frictional connection and positive locking connection, the slide ring 16 is entrained in rotation. The counter ring 19 and the securing element 37 are stationarily arranged and secured on the inner wall 33 of the mounting space 3. The end face 17 of the slide ring 16 is positioned seal-tightly on the end face 18 of the counter ring 19. The housing 1 is designed such that it surrounds positive-lockingly the drive shaft 2 about the entire circumference in the area in front of and behind the annular seal 23. In this way, the torque between the slide ring 16 and the drive shaft 2 is transmitted properly. The hydraulic configuration of the mechanical seal assembly, the so-called k factor, is determined as a result of this configuration only by the relatively easily realizable shaft fit at this location. As a result of this configuration the housing is supported also in the radial direction so that the hydraulic configuration of the mechanical seal assembly cannot be affected negatively by pressure-dependent deformations. Also, the housing 1 can be designed very thin as a results of the described configuration.

The sealing ring 14 and the annular seal 23 have almost identical inner sealing diameters wherein the sealing ring 14 is seated immediately on the drive shaft 2 while the annular seal 23 is seated on the wall section 7 of the housing 1. In this connection, the sealing ring 14 has a smaller radial thickness than the annular seal 23. At the side of the closure element 41 the low-pressure side 44 is located and at the opposite side of the mechanical seal assembly the high-pressure side 45 is provided. Since the sealing ring 14 is positioned on a diameter similar to the sealing diameter of the annular seal 23 behind the slide ring 16, an axial displacement of the mechanical seal assembly in the direction toward the low-pressure side 44 by attacking pressure forces is prevented. In this way, an axial support of the mechanical seal assembly on the shaft is not required.

In the illustrated embodiment, the sealing ring 14 is seated on the cylindrical wall surface of the drive shaft 2. It is also possible to provide the drive shaft 2 with an annular groove for the sealing ring 14 in which groove the sealing ring 14 is housed. In this case, the sealing ring 14 must be mounted on the drive shaft 2 before the mechanical seal assembly can be mounted on the drive shaft 2. In this case, the cylindrical part 9 of the housing 1 has a smaller diameter. Accordingly, the flange 8 has also a reduced radial width in comparison to the illustrated embodiment. The sealing ring 14 can be secured properly in the axial direction by means of the annular groove of the drive shaft 2, the annular groove having a sidewall against which the sealing ring 14 can rest, so that additional axial securing elements are not required.

In the illustrated embodiment, the securing ring 15 and the washer 12 are provided for axially securing the sealing ring 14.

The disclosed mechanical seal assembly can be utilized optimally for all dynamic sealing locations subjected to pressure loading and/or having only limited mounting space available.

The specification incorporates by reference the entire disclosure of German priority document 10 2007 025 773.4 having a filing date of May 22, 2007.

While specific embodiments of the invention have been shown and described in detail to illustrate the inventive principles, it will be understood that the invention may be embodied otherwise without departing from such principles.

What is claimed is:

1. A mechanical seal assembly comprising:
a housing fixedly secured on the shaft to be sealed;
a slide ring positive-lockingly connected to the housing;
a counter ring interacting with the slide ring;
wherein the housing is frictionally connected to the shaft on a side of the slide ring facing away from the counter ring.

2. The mechanical seal assembly according to claim 1, further comprising a secondary seal disposed in a cutout of the slide ring.

3. The mechanical seal assembly according to claim 2, further comprising an axial securing element that secures the secondary seal in the cutout of the slide ring.

4. The mechanical seal assembly according to claim 3, wherein the axial securing element is an annular disk positioned in a radial plane of the mechanical seal assembly.

5. The mechanical seal assembly according to claim 1, further comprising a sealing element in the form of a sealing ring.

6. The mechanical seal assembly according to claim 5, wherein the sealing element is secured by at least one axial securing element.

7. The mechanical seal assembly according to claim 6, wherein the axial securing element is an annular disk seated on the shaft.

8. The mechanical seal assembly according to claim 6, wherein the axial securing element is a sidewall of an annular groove provided in the shaft.

9. The mechanical seal assembly according to claim 1, further comprising a secondary seal disposed in a cutout of the slide ring and a sealing element in the form of a sealing ring, wherein the secondary seal and the sealing ring have at least approximately the same sealing diameter.

10. The mechanical seal assembly according to claim 1, wherein the slide ring is connected positive-lockingly to the housing in a direction of rotation of the shaft.

11. The mechanical seal assembly according to claim 1, comprising at least one securing element providing a positional securing action for the mechanical seal assembly, wherein the at least one securing element is fixedly secured to a wall of a mounting space in which mounting space the mechanical seal assembly is mounted.

12. The mechanical seal assembly according to claim 11, wherein the wall of the mounting space has an annular groove and the at least one securing element engages the annular groove.

13. The mechanical seal assembly according to claim 1, further comprising at least one closure element disposed on the housing, wherein the at least one closure element positionally secures at least the slide ring and the counter ring.

14. The mechanical seal assembly according to claim 13, wherein the at least one closure element is a ring seated on a housing wall of the housing.

15. The mechanical seal assembly according to claim 13, wherein the at least one closure element is a tongue that is bent out of a wall section of the housing.

16. The mechanical seal assembly according to claim 1, wherein the counter ring is located at a low-pressure side of the mechanical seal assembly and the slide ring is located at a high-pressure side of the mechanical seal assembly.
